(19) United States
(12) Patent Application Publication
(10) Pub. No.: US 2015/0024137 A1
(43) Pub. Date: Jan. 22, 2015

(54) Method for the application of an aqueous treatment solution on the surface of a moved steel strip

(71) Applicant: ThyssenKrupp Rasselstein GmbH, Andernach (DE)

(72) Inventors: Andrea Marmann, Piesport (DE); Michael Wild, Neuwied Irlich (DE); Paul Michels, Arzbach (DE)

(21) Appl. No.: 14/332,078

(22) Filed: Jul. 15, 2014

(30) Foreign Application Priority Data
Jul. 16, 2013 (DE) 102013107505.3

(51) Int. Cl. B05C 11/02; B05D 1/40; B05D 1/02; B05D 3/04; B05D 3/12

(52) U.S. Cl. CPC B05C 11/021; B05D 3/0466; B05D 3/12; B05D 1/02; B05D 1/40; B05C 11/025
USPC 427/318; 148/243; 148/273; 148/247; 148/253; 148/274; 118/58; 205/152

(57) ABSTRACT

An apparatus and method for the application of an aqueous treatment solution onto the surface of a steel strip that is moved, at a prespecified strip speed, in a direction of movement of the strip, with the following steps: drying of the moving steel strip with a gas flow; application of the aqueous solution on at least one surface of the steel strip with a rotary sprayer with several spray rotors that are situated next to one another, transverse to the direction of movement of the strip, to which the aqueous treatment solution is supplied and which are rotated by a drive, so as to spray the treatment solution, as a result of centrifugal force, in the form of a spray jet, onto the surface of the steel strip and, there, to form a wet film of the aqueous treatment solution; equalization of the applied wet film of the aqueous treatment solution by driven smoothing rollers; and drying of the applied wet film of the aqueous treatment solution.

### CROSS REFERENCE TO RELATED APPLICATION

This application claims priority under 35 U.S.C. §119 to German Patent Application No. 10 2013 107 505.3 filed 26 Jul. 2013, the entire contents of which are incorporated herein by reference.

### FIELD OF THE DISCLOSURE

The disclosure concerns a method and an apparatus for the application of an aqueous treatment solution on the surface of a steel strip which is moved at a prespecified strip speed in the movement direction of the strip.

### BACKGROUND OF THE DISCLOSURE

The treatment of the coated surface of a steel sheet that is coated with a metal anti-corrosion layer after the application of the metal coating with an aftertreating agent, so as to make the coated steel sheet resistant to oxidation and to lower the friction coefficient, so that the coated steel sheet can be processed better in the subsequent processing, for example, during the production of packaging containers is known from the state of the art. From DE 10 2005 045 034 A1, for example, a method for the passivation of the surface of metal-coated steel strips, in particular, tin plate (tinned steel sheets), is known, wherein an aqueous solution of a surface-active substance is sprayed on the surface of a steel strip that is moved at a strip speed in the range of 100 m/min to 600 m/min. The surface-active substance is thereby sprayed via at least one tube, which is situated at a distance to the coated steel strip surface and has at least one borehole, through which the aqueous solution of the surface-active substance is sprayed on the metal-coated surface of the steel strip, or on each metal-coated surface. After the spraying of the aqueous solution, the excess fraction of the solution is squeezed off the surface by means of squeezing rollers. The wet film of the surface-active substance that remains on the coated steel strip surface is finally dried, so that a dry, thin film of the surface-active substance, with a layer between 2 and 10 mg/m², remains on the metal-coated surface of the steel strip.

Another method for the aftertreating agent treatment of a steel strip, in particular, a tin plate strip, which is provided with a metal coating, is known from DE 10 2012 102 082 B3. In this method, an aqueous aftertreating agent solution is sprayed on the metal-coated surface of the steel strip by means of a spraying method. As an alternative for the spraying of the aqueous solution of the aftertreating agent by means of a spraying method, the application of the aftertreating agent with an immersion method can also be taken into consideration, in which the steel strip is conducted through a tank that is filled with the liquid aftertreating agent. Both with the known spraying method as well as with the immersion method, it is necessary to apply the aqueous solution of the treatment agent, in excess, on the surface in order to attain a homogeneous distribution of the treatment agent over the entire surface of the steel strip and the removal, again, of the excess fraction of the treatment solution, for example, with squeezing rollers. Therefore, both the traditional spraying method as well as the known immersion method have the disadvantage that large quantities of the aqueous treatment solution are required and that the excess part of the treatment solution, which, for example, is squeezed off the surface of the steel strip by means of squeezing rollers, must be collected in collecting containers and conducted to a recycling unit. A recycling of a treatment solution, which was already applied once on a metal-coated surface of a steel strip, proves to be, however, cumbersome and expensive, because the treatment solution may be contaminated by the application on the steel strip surface, for example, by metal ions from the metal coating of the steel strip. Thus, for example, an application of an aqueous treatment solution on a tin plate surface leads to a contamination of the treatment solution with tin ions from the tin coating.

In particular in the known immersion method, there is also frequently a nonuniform application of the aqueous treatment solution on the surface of the steel strip. This manifests itself, above all, when the steel strip is moved at a high strip speed of, for example, more than 400 m/min through an immersion bath with the treatment solution. Moreover, with the immersion method, there is the problem of an ageing of the aqueous treatment solution which is kept in stock in the immersion bath (tank). In conducting a metal-coated steel strip through an immersion bath, there is also a contamination of the treatment solution, in particular, due to soiled surfaces of the steel strip and through the detachment of metal ions from the coating material of the metal coating of the steel strip. The problem of the ageing of aqueous treatment solutions in an immersion bath arises, for example, with chromium-free passivation agents, which are used for the passivation of tin plate surfaces.

### SUMMARY OF THE DISCLOSURE

For this reason, there is a need for a material-sparing method for the application of an aqueous treatment solution on the surface of a moved steel strip, with which a uniform application of the treatment solution on the steel strip surface is made possible. A goal of embodiments of the disclosure, therefore, consists of indicating a method for the application of an aqueous treatment solution on the surface of a moved steel strip, with which, while using the lowest possible quantities of the treatment solution, a uniform application of the treatment solution on the steel strip surface is made possible. Another goal of embodiments of the disclosure consists in making available a method for the application of an aqueous treatment solution on the surface of a moved steel strip, with which, to avoid ageing effects, the treatment solution can be applied, as fresh as possible, after its deposition on the steel strip surface. It should be thereby possible to also carry out the application method at high strip speeds of the moved steel strip.

In the method in accordance with the disclosure, an application of an aqueous treatment solution takes place on the surface of a steel strip that is moved at a prespecified strip speed in a direction of movement of the strip by application of the aqueous treatment solution on one or both surfaces of the moved steel strip with a rotary sprayer, which has several spray rotors, located, next to one another, transverse to the direction of movement of the strip, to which the aqueous treatment solution is supplied and which are made to rotate by a drive, so as to spray the aqueous treatment solution, as a result of centrifugal force, in the form of a fine spray jet onto the surface of the steel strip, or onto each surface, and to form, there, a wet film of the aqueous solution. Before the spraying of the aqueous treatment solution, the moved steel strip is dried and cleaned with a gas flow. After the application of the wet film of the aqueous treatment solution, it is evened out on the steel strip surface by means of driven smoothing rollers. The smoothing rollers are thereby appropriately situated, relative to the steel strip surface(s), in such a way that they do not exert any pressure on the wet film of the aqueous treatment solution, or only a small amount of pressure, and, therefore, do not squeeze off a fraction of the applied treatment solution, or only a minimal fraction, from the steel strip surface. After the sprayed wet film has been evened out, it is dried, so that a dry layer of the treatment substance remains on the treated steel strip surface(s). The dry layer of the treatment solution is appropriately between 1 and 50 mg/m² after drying.

The gas flow with which the moved steel strip is cleaned and dried before the application of the aqueous treatment solution is appropriately prepared by an Air-Knife and blown, as a laminar hot airflow, onto the surface of the moving steel strip. In this way, disturbing foreign particles are blown off the steel strip surface, and the steel strip surface is dried.

The quantity of the aqueous treatment solution that is supplied to the spray rotors of the rotary sprayer per unit time is appropriately adapted to the strip speed. There is appropriately a linear connection between the quantity of the treatment solution that is supplied to the spray rotors per unit time and the strip speed. The quantity of the treatment solution that is supplied to the spray rotors per unit time and related to the width of the steel strip and per side is preferably between 0.4 to 5.5 liters per minute and meter is, with particular preference, in a range between 1 to 3.5 liters per minute and meter, wherein the strip speed is, as a rule, between 200 and 700 m/min. The layer of the wet film of the treatment solution that was sprayed with the spray rotors onto the surface side of the steel strip, or onto each surface side, is correspondingly in the preferred range of 2 to 8 mL/m² per side of the steel strip and, preferably, between 4 and 6 mL/m² and, with particular preference, ca. 5 mL/m².

In order to squeeze off as little excess treatment solution as possible from the steel strip surface, the applied wet film of the aqueous solution is evened out by means of driven smoothing rollers, wherein the smoothing rollers preferably comprise a pair of smoothing rollers with two driven smoothing rollers located, staggered, relative to one another. The distance of the smoothing rollers to the steel strip surface can thereby be appropriately adjusted and adapted to the quantity (layer) of the wet film of the treatment solution that is sprayed with the rotary sprayer. Thus, as a function of the sprayed quantity or the layer of the wet film of the treatment solution, it is possible to attain, on the one hand, an equalization of the applied wet film over the entire width of the steel strip, without, on the other hand, having to squeeze off again excessively large quantities of the sprayed-on wet film from the steel strip surface. As a result, it is no longer necessary, or it is still necessary only to a very small extent, to again collect excess treatment solution, which is squeezed off or dripped off from the steel strip surface, and to conduct it to a preparation site.

The rotary sprayer is appropriately connected, via a supply line, with a supply container, in which the aqueous treatment solution is kept in stock. The aqueous treatment solution can be supplied to the rotary sprayer from the container and, via the supply line, using a pump. In the supply container, only fresh treatment solution is, appropriately, kept in stock, so as to avoid ageing problems. In contrast to the known immersion method, the treatment solution that is kept in stock in the supply container does not come into contact with a (perhaps metal-coated) steel strip before its application on the steel strip surface, which could lead to a contamination of the fresh treatment solution (for example, by detachment of the metal ions from the metal coating).

The method in accordance with the disclosure is primarily characterized by its careful resource use of the treatment solution to be applied and by its cost efficiency. In contrast to the known application methods, only the precisely needed quantity of the treatment solution is sprayed onto the steel strip surface, without any excess of treatment solution having to again be blown off or squeezed off. As a result, it is no longer necessary either to collect excesses of the treatment solution that are squeezed off from the steel strip surface or to conduct them to a recycling site. In this way, it is also possible to avoid wastewater that has to be treated subsequently and is yielded in recycling processes.

The application method in accordance with the disclosure is suitable for the application of different treatment solutions onto moved steel strips. By using the method in accordance with the disclosure, it is possible, for example, to apply passivation solutions or aftertreating solutions onto tin plate surfaces for the reduction of the coefficient value. The method in accordance with the disclosure, however, can also be used, in an appropriate manner, for the application of other aqueous treatment solutions on tin plate surfaces or also on the surface of steel strips, which are coated with other metal coatings (such as tin- or chromium-containing coatings). The method in accordance with the disclosure can also be used for the application of aqueous treatment solutions on uncoated steel strips, such as, for the application of an aqueous conversion coating on the surface of black plates (hot- or cold-rolled, not descaled, and uncoated steel plates).

### BRIEF DESCRIPTION OF THE DRAWINGS

These and other features and advantages of the method in accordance with the disclosure and the apparatus in accordance with the disclosure can be deduced from the embodiment example, which is described in more detail, below, with reference to the accompanying drawings. The drawings show the following:

FIG. 1: Schematic representation of an apparatus for the carrying out of the method in accordance with the disclosure;

FIG. 2: Detailed view of a section of the apparatus of FIG. 1 in the area of the rotary sprayer and perspective top view of this rotary sprayer.

### DETAILED DESCRIPTION OF THE DISCLOSURE

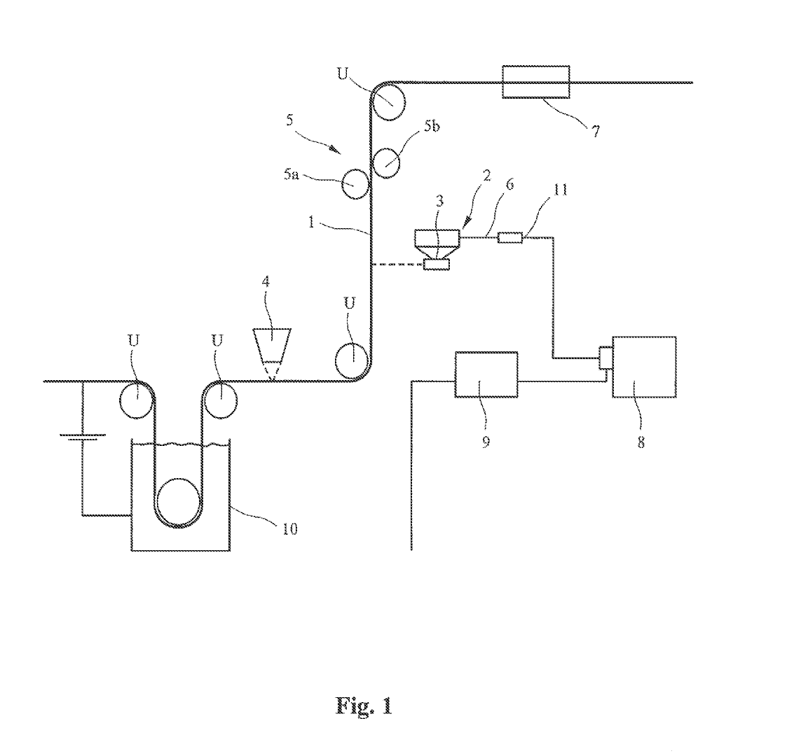

FIG. 1 schematically shows an apparatus for the carrying out of the method, in accordance with the disclosure, for the application of an aqueous treatment solution on the surface of a moved steel strip. The steel strip 1 is thereby conducted via several deflection rollers U and is moved, at a prespecified strip speed v, in a direction of movement of the strip, which is marked, in FIG. 1, with an arrow. The strip speed is thereby, as a rule, more than 200 m/min and up to 750 m/min. The steel strip 1 can be a cold-rolled steel strip, coated with a metal coating, for example, a tin plate strip or a tinned steel strip. However, it can also be an uncoated steel plate, such as a black plate strip.

The steel strip 1 is moved by a nondepicted transport device, at a prespecified strip speed v, in a direction of movement of the strip and is thereby conducted with the use of deflection rollers U. First, the steel strip 1 is conducted by a first drying device 4, so as to dry and clean the surfaces of the steel strip 1. The first drying device 4 is thereby formed, for example, by an “Air-Knife,” which blows a laminar hot airflow onto the surfaces of the steel strip 1, which moves through at the strip speed v, so as to dry, in this way, the steel strip surfaces and blow off disturbing foreign particles.

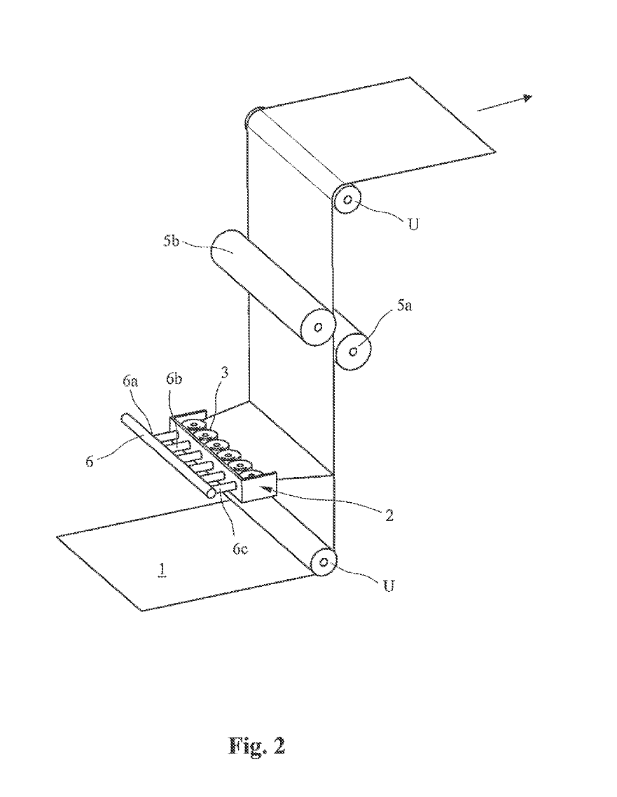

The first drying device 4 is followed by a rotary sprayer 2. The rotary sprayer is shown in detail in FIG. 2. The rotary sprayer 2 has several spray rotors 3, located, next to one another, transverse to the direction of movement of the strip, and at a distance to one another. The spray rotors 3 are connected, via a central supply line 6 and branch lines 6a, 6b, 6c, etc., branching off from there, with a supply container 9. The aqueous treatment solution is kept in stock in the supply container 9; it is to be applied on the steel strip surface. The aqueous treatment solution is appropriately pumped into the supply line 6 by means of a pump 8; from there, it is conducted into the branch lines 6a, 6b, 6c, wherein each branch line is connected with one of the spray rotors 3. A throughflow gauge 11 is appropriately provided in the supply line 6 to record the quantity of the aqueous treatment solution that is pumped into the supply line 6.

Via the supply line 6 and the branch lines arranged thereon, the aqueous treatment solution is supplied to the spray rotors 3 of the rotary sprayer 2. The spray rotors 3 have a plate that is rotated by a drive. As a result of the rotation of the plate of the spray rotors 3, the supplied aqueous treatment solution is conveyed outward to the edge of the plate by centrifugal force. The edge of the plate is shaped in such a way that the aqueous treatment solution flies off in the form of fine droplets from the edge of the rotating plate. As a function of the viscosity and the surface tension of the treatment solution used, the droplet diameter lies, as a rule, between 30 and 70 micrometers. The droplets of the treatment solution that fly away from the edge of the plate are completely sprayed around the rotating plate of the spray rotors 3. The spray rotors 3 are arranged transverse to the direction of movement of the strip, in such a way, that the spray jets 12 of adjacent spray rotors 3 overlap on the surface of the steel strip 1, so as to provide a uniform application of the aqueous treatment solution over the entire width B of the steel strip 1.

The quantity of the aqueous treatment solution that is supplied to the spray rotors 3 per unit time is thereby appropriately adapted to the strip speed v, at which the steel strip 1 is moved. There is thereby a linear relationship between the quantity of the treatment solution that is supplied to the spray rotors per unit time and the strip speed v. The quantity M of the treatment solution that is supplied to the spray rotors per unit time Δt and that is relative to the width B of the steel strip 1 thereby varies, as a rule, between M/Δt·B=0.4 to 5.5 liters per minute and meter and preferably lies between M/Δt·B=1.0 to 3.5 liters per minute and meter. At a typical strip speed of 200 to 700 m/min, the quantity of the wet film of the treatment solution that is sprayed onto the surface of the steel strip 1 with the spray rotors 3 is between 2 and 8 mL/m² and, preferably, between 4 and 6 mL/m², and, with particular preference, ca. 5 mL/m².

The aqueous treatment solution can be sprayed, by means of the rotary sprayer 2, either only on one side of the steel strip 1, or also on both sides of the surfaces of the steel strip 1. Under certain circumstances, rotary sprayers 2 are located, for the purpose, on both sides of the steel strip 1 that is passed through.

After the application of the aqueous treatment solution as a wet film on the surface of the steel strip 1, or on each surface, the steel strip 1 is passed between smoothing rollers 5a, 5b, which are driven in a rotating manner. The smoothing rollers 5 serve to equalize the applied wet film of the aqueous solution. Preferably, a pair of smoothing rollers 5, with two smoothing rollers 5a and 5b, which are located staggered with respect to one another, are used for the purpose. The staggered arrangement of the smoothing rollers 5a, 5b is shown in the figures. As can be seen from the figures, the smoothing rollers 5a, 5b are situated relative to one another, in such a way, that the connecting line of the rotation axes of the smoothing rollers, which run parallel to one another and parallel to the steel strip surface, enclose, in the cross section with the steel strip 1 that is passed through the two smoothing rollers, an angle of ca. 30° to 60° and, in particular, 45°. In contrast to the squeezing rollers known from the state of the art, which are arranged symmetrical to the steel strip and exert a contact pressure, so as to squeeze off excess treatment solution from the steel strip surface, the smoothing rollers used here do not exert a substantial contact pressure on the steel strip surface. Thus, a fraction of the sprayed-on treatment solution is not squeezed off, or only a very small fraction, from the steel strip surface. The smoothing roller pair 5 leads only to an equalization of the wet film of the treatment solution over the entire surface of the steel strip. Thus, a constant application of a wet film of the treatment solution, with a homogeneous layer thickness over the entire surface of the steel strip, is guaranteed, and it prevents excess treatment solution, which would have to be collected and supplied to a recycling unit, from being yielded.

Following the smoothing rollers 5, the steel strip 1 is conducted through a second drying device 7. The second drying device 7 can be a drying furnace or an infrared or hot air drier.

After the drying, a uniform dried layer of the treatment solution remains on the surface of the steel strip 1, or on each surface, wherein after the drying, the dried layer is, as a rule, between 1 and 50 mg/m² and, preferably, between 2 and 30 mg/m². With particular preference, the dried layer of the treatment solution is ca. 10 mg/m².

The aqueous treatment solution can be, for example, a chromium-free, surface-active passivation solution, as it was described in DE 10 2005 045 034 A1 for the chromium-free passivation of tin plate surfaces. The aqueous treatment solution can also be a chromium-free passivation solution for the passivation of tin plate, which contains water-soluble, inorganic compounds of the elements zirconium and titanium or aluminum. Such aqueous treatment solutions can be used in a two-stage passivation method for the passivation of tin plate, wherein in a first stage, an anodic oxidation of the tin plate surface is carried out, and in a second stage, the application of the aqueous treatment solution on the tin plate surface takes place, wherein the treatment solution contains water-soluble, inorganic compounds of the elements zirconium and/or titanium or aluminum. The application of the aqueous treatment solution can thereby take place with the method in accordance with the disclosure.

The first step of the anodic oxidation of the tin plate surface then has to also be put first in the application of the aqueous treatment solution with the method in accordance with the disclosure. To this end, as shown schematically in FIG. 1, the steel strip 1 is conducted, at the prespecified strip speed v, through a tank 10 with an aqueous electrolyte (for example, a soda solution) and connected in an electric circuit as an anode, so as to anodically oxidize the tin plate surface. It has become evident that a particularly inert oxidation layer is formed on the tinned surface of the tin plate by such an anodic oxidation of the tin plate surface; it essentially consists of (inert) tetravalent tin oxide SnO₂, and protects the tin plate surface against the natural growth of an oxide layer due to air oxygen or against reactions with sulfur-containing materials. Such an anodic oxidation of a tin plate surface, with a subsequent treatment of the oxidized surface with a chromium-free, aqueous aftertreating agent, which, in particular, contains titanium and/or zirconium, can therefore comprehensively protect the tinned surface of the steel strip against corrosion and against a discoloring of the surface due to a reaction of the tin with sulfur.

With the method in accordance with the disclosure, it is also possible to apply a metal or organic conversion coating on a black plate (uncoated, cold- or hot-rolled steel plate). It has become evident that the method in accordance with the disclosure is suitable, for example, for applying conversion coatings on black plate, which contain metal components, such as titanium, zirconium, manganese, zinc, or also phosphorus, or organic components, such as polyacrylate or polycarboxylate. Such conversion coatings offer a good protection to the surface of the black plate against corrosion, so that black plate treated accordingly, for example, as a replacement for steel plate which is coated with a metal anti-corrosion layer made of chromium (such as ECCS, “electrolytic chromium coated steel”), can be used.

What is claimed is:

1. Method for the application of an aqueous treatment solution on the surface of a steel strip that is moved, at a prespecified strip speed, in a direction of the movement of the strip, with the following steps:
drying of the moving steel strip with a gas flow;
application of the aqueous solution on at least one surface of the steel strip with a rotary sprayer with several spray rotors that are situated next to one another, transverse to the direction of movement of the strip, to which the aqueous treatment solution is supplied and which are rotated by a drive, so as to spray the treatment solution, as a result of centrifugal force, in the form of a spray jet, onto the surface of the steel strip and, there, to form a wet film of the aqueous treatment solution;
equalization of the applied wet film of the aqueous treatment solution by driven smoothing rollers;
drying of the applied wet film of the aqueous treatment solution.

2. Method according to claim 1, wherein the gas flow is blown onto the surface of the moving steel strip, for the drying of the moving steel band with an Air-Knife, as a laminar hot airflow.

3. Method according to claim 1, wherein the quantity of the treatment solution that is supplied to the spray rotors per unit time is adapted to the strip speed at which the steel strip is moved.

4. Method according to claim 3, wherein a linear relationship exists between the quantity of the treatment solution that is supplied to the spray rotors per unit time and the strip speed.

5. Method according to claim 1, wherein the quantity (M) of the treatment solution that is supplied to the spray rotors per unit time (Δt) and relative to the width (B) of the steel strip lies between M/Δt*B=0.4 to 5.5 liters per minute and meter (l/min*m) and, preferably, between M/Δt*B=1.0 to 3.5 liters per minute and meter (l/min*m).

6. Method according to claim 1, wherein the strip speed lies between 200 and 700 m/min.

7. Method according to claim 1, wherein the quantity of the wet film of the treatment solution that is applied with the spray rotors onto the surface side of the steel strip, or onto each surface side, is between 2 mL/m² and 8 mL/m² and, preferably, between 4 mL/m² and 6 mL/m², and, with particular preference, ca. 5 mL/m².

8. Method according to claim 1, wherein after the drying, the dried layer of the treatment solution lies between 1.0 mg/m² and 50 mg/m², and, preferably, between 2 mg/m² and 30 mg/m², and, with particular preference, ca. 10 mg/m².

9. Method according to claim 1, wherein the equalization of the applied wet film of the aqueous solution takes place by a driven pair of smoothing rollers with two smoothing rollers that are situated staggered with respect to one another.

10. Method according to claim 1, wherein the steel strip is a tinned steel strip (tin plate) and that the aqueous treatment solution is a passivation solution for the passivation of the tin coating, in particular, a chromium passivation solution.

11. Method according to claim 1, wherein the steel strip is an uncoated steel strip (black plate) and that the aqueous treatment solution is a metal-containing or an organic treatment solution for the application of an anti-corrosion conversion coating onto the surface of the steel strip (black plate).

12. Method according to claim 10, wherein before the application of the aqueous treatment solution, an anodic oxidation of the surface of the steel strip is carried out, which preferably takes place by conducting the steel strip through a basic electrolyte at the strip speed.

13. Method according to claim 10, wherein the aqueous treatment solution (passivation solution) contains copolymers of acrylate, polymethyl siloxane with polyether side chains, acidic polyether, polymers with heterocyclic groups and/or acidic compositions with complex metal-fluoride anions with divalent or tetravalent cations and polymeric substances.

14. Method according to claim 1, wherein the aqueous treatment solution contains titanium and/or zirconium or aluminum, in particular, aluminum nitrate.

15. Method according to claim 11, wherein the aqueous treatment solution contains at least one of the following components: titanium, zirconium, manganese, zinc, phosphorus, polyacrylate, or polycarboxylate.

16. Apparatus for the carrying out of the method according to claim 1, with:
a transport device for transporting the steel strip in a direction of movement of the strip, at a prespecified strip speed;
a first drying device for the drying of the steel strip;
at least one rotary sprayer with several spray rotors that are situated next to one another, transverse to the direction of movement of the strip, wherein the rotary sprayer for the application of the aqueous treatment solution onto at least one surface of the steel strip is situated at a distance to this surface of the steel strip;
a supply device for supplying the rotary sprayer with the treatment solution, with a supply line, which is connected with the rotary sprayer and with a supply container for the aqueous treatment solution;
a drive, with which the spray rotors of the rotary sprayer are made to rotate, so as to spray the aqueous treatment solution, as a result of centrifugal force, in the form of a spray jet, onto the surface of the steel strip and, there, to form a wet film of the aqueous solution;
a pair of driven smoothing rollers, which are subordinated to the rotary sprayer in the direction of movement of the strip and which are used for the equalization of the applied wet film of the aqueous solution on the surface of the steel strip;
a second drying device for the drying of the applied wet film of the aqueous solution.

17. Apparatus according to claim 16, wherein the supply device comprises a pump, which is connected with a control that is coupled with the transport device, so as to adapt the quantity of the treatment solution that is supplied to the rotary sprayer per unit time to the strip speed.
